(19) United States
(12) Patent Application Publication
(10) Pub. No.: US 2022/0374406 A1
(43) Pub. Date: Nov. 24, 2022

(54) KV Database Configuration Method, Query Method, Device, and Storage Medium

(71) Applicant: HANGZHOU FUZAMEI TECHNOLOGY CO. LTD, HangZhou, Zhejiang (CN)

(72) Inventors: Zhiwen WANG, Suzhou (CN); Sijin WU, Suzhou (CN)

(21) Appl. No.: 17/604,996

(22) PCT Filed: Apr. 29, 2020
(86) PCT No.: PCT/CN2020/087827

§ 371 Date: Jul. 28, 2022

(30) Foreign Application Priority Data
May 31, 2019 (CN) 201910470256.1

(51) Int. Cl. G06F 16/22

(52) U.S. Cl. CPC G06F 16/2282; G06F 16/2272; G06F 16/2264

(57) ABSTRACT

A KV database configuration method, a query method, a device, and a storage medium, wherein the method comprises: taking unique index data of a first data table as a key value, taking a plurality of common index data as value value, and storing the first data table into a data storage area (S11); taking first index information generated according to the first data in the first data table as the key value, taking the unique index data of the first data as the value value, and generating a plurality of index data pairs and storing the index data pairs into the index storage area (S12); wherein, the first index information comprises the name of the first index, and the index data of the first index in the first data. The method realizes automatically storing all relational data in the data table into the kv database, greatly simplifies the workload of manually constructing the kv, and meanwhile, a common kv database can also achieve the effect of a relational database.

### FIELD OF INVENTION

The present invention relates to the technical field of information storage, and more particularly to a KV database configuration method, query method, device, and storage medium.

### DESCRIPTION OF RELATED ARTS

Currently, a kv (key-value) database is a non-relational database, that is not suitable to store service data of some data relationship services. There is kv database in the current industry to implement a relational database, for example, utilizing a TiDB database of TiKV, but such a database is generally customized to meet the data relationship required by the developer, and it is difficult to implement that the database wants to query non-customized common relational data.

### SUMMARY OF THE PRESENT INVENTION

In accordance with the defects or drawbacks of the conventional technologies, the present invention aims to provide a universal and KV database configuration method, query method, device, and storage medium.

In a first aspect, the present invention provides a KV database configuration method, comprising:

taking an unique index data of a first data table as “key”, taking a plurality of regular index data as “value”, and storing the first data table in a data storage area; and

taking a first index information generated according to a first data in the first data table as “key”, taking a unique index data of the first data as “value”, and generating a plurality of index data pairs and storing the index data pairs in an index storage area,

wherein the first index information includes a name of the first index and a index data of the first index in the first data.

Further, the first index information also comprises the unique index data of the first data.

Further, when the unique index data is absent from the first data table, automatically disposing the unique index data for the first data table.

Further, the unique index data has a fixed number of bits, and if not, filling zero in front of the unique index data to satisfy the number of bits.

Further, the method further comprises:

generating an association table of a plurality of data tables according to the data tables, wherein the association table comprises index data combinations of the data tables and the unique index data corresponding to the index data combinations in the data tables.

In a second aspect, the present invention provides a KV database query method, which is adapted for single-table querying, comprising the following steps:

generating a first query index data according to a first information query content information and determining if the first query index data the same to the unique index data:

if yes, generating a query result according to a query of a storage area of the unique index data;

if no, generating the query result according to a query of a first query index data in an index storage area.

In a third aspect, the present invention provides a KV database query method, which is adapted for association table querying, comprising the following steps:

generating a second query index data according to a second information query content and acquiring a plurality of index data from an association table according to the second query index data; and

acquiring a required data information from each of corresponding data tables according to index data.

In a fourth aspect, the present invention also provides a device, which includes one or more processors and a storage unit, wherein the storage unit includes commands executable by the one or more processors to allow the one or more processors to perform the KV database configuration method and query method provided in accordance with embodiments of the present invention.

In a fifth aspect, the present invention also provides a storage medium with one or more computer programs stored therein so as for allowing a computer to perform a KV database configuration method and query method provided in accordance with the embodiments of the present invention.

Beneficial effects of the present invention include the following:

The KV database configuration method, query method, device, and storage medium according to the embodiments of the present invention takes the unique index data of the data tables as a key value; takes the plurality of regular index data as a value, and stores the data in the data storage area as well as takes the first index information in the data table as a key value; takes the unique index data of the first data as a value, and generates a plurality of index data and stores them in an index storage area, which achieves that the data in all the existing relationships in the data tables are automatically stored within the kv database, so that the workload of manually constructing the kv (key-value) is greatly simplified, and meanwhile, an ordinary kv database can also achieve the effect as a relational database and allow querying of all data relationships by means of the kv database.

### BRIEF DESCRIPTION OF THE DRAWINGS

Other features, objects, and advantages of the present application become more obvious through referring to the detail descriptions of the embodiments that are illustrated in, but not limited by the following figures.

FIG. 1 (a) and (b) are schematic views of user data tables according to a preferred embodiment of the present invention.

FIG. 2 is a flow diagram of a KV database configuration method according to the above preferred embodiment of the present invention.

FIG. 3 is a schematic view illustrating a preferred application of the method as shown in FIG. 2 according to the preferred embodiment of the present invention.

FIG. 4 is a schematic view illustrating a preferred application of the method as shown in FIG. 2 according to the preferred embodiment of the present invention.

FIG. 5 is a flow diagram of the method as shown in FIG. 2 according to the preferred embodiment of the present invention.

FIG. 6 is a schematic view illustrating a preferred application of the method as shown in FIG. 5 according to the preferred embodiment of the present invention.

FIG. 7 is a flow diagram of a KV database query method according to the above preferred embodiment of the present invention.

FIG. 8 is a flow diagram of a KV database query method according to another preferred embodiment of the present invention.

FIG. 9 is a composition diagram of a device according to the above preferred embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

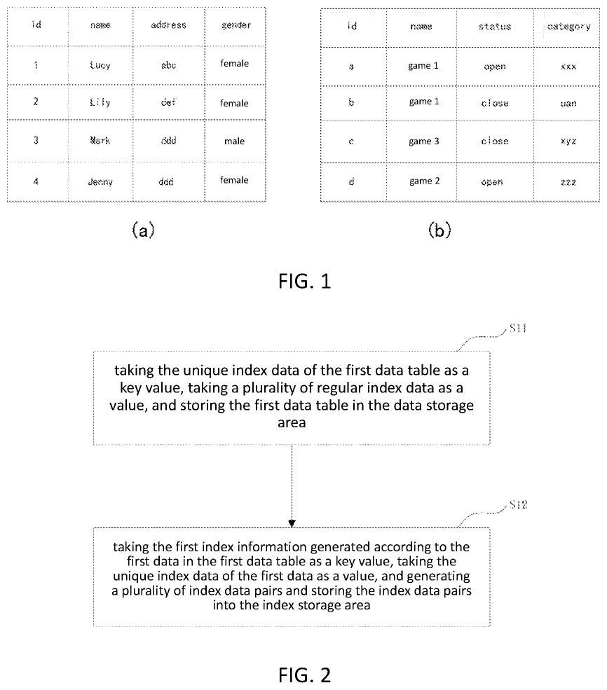

FIG. 1 illustrates schematic views of user data tables according to a preferred embodiment of the present invention. Referring to FIG. 1, according to the preferred embodiment, the id in the table is utilized as the only index (primary), the 1, 2, 3 . . . corresponding to the id are unique index data of the table. The unique index data represent the data non-repetitive to data in a user data table and are in one-to-one correspondence with the user data table, while the name, address, gender, and etc. are common index (index), which are corresponding to regular index data.

FIG. 2 is a flow diagram of a KV database configuration method according to the preferred embodiment of the present invention.

Referring to FIG. 2, according to the preferred embodiment, the present invention provides a KV (Key-Value) database configuration method, comprising:

S11 taking a unique index data of a first data table as “key”, taking a plurality of regular index data as “value”, and storing the first data table in a data storage area;

S12 taking a first index information generated according to a first data in the first data table as a “key”, taking the unique index data of the first data as a “value”, and generating a plurality of index data pairs and storing the index data pairs in an index storage area;

wherein the first index information includes a name of a first index and an index data of the first index in the first data.

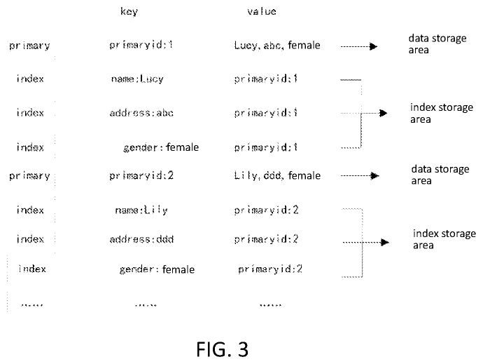

In particular, referring to FIG. 3, taking the data table illustrated in FIG. 1 as an example, the id in the user data table is utilized as an unique index, so the unique index data “primaryid:1” is utilized as the “key” of the kv database and the rest of the data in the row with the id listed as “1” being processed as the “value” value of the kv database, wherein the processing method for the rest of the data in the row utilizes a current processing technology to generate a plurality of key-value data to be stored in the data storage area. Take the “name” as a regular index, then the “name:Lucy” is taken as a “key” and the “primaryid:1” is taken as a “value”. Take the “address” as a regular index, then the “address:Lucy” is taken as a “key” and the “primaryid:1” is taken as a “value”. Take the “gender” as a regular index, then the “gender:Lucy” is taken as a “key” and the “primaryid:1” is taken as a “value”. Also, store the above regular index data in the index storage area; accordingly, all data with the id listed as “1” have been automatically stored in the kv database.

Based on the same principle, store the data with the id listed as “2” in the kv database, store the data with the id listed as “3” in the kv database, . . . , and etc.

In other embodiments, the definition of the “key” can further include other contents that are capable of marking this data table in addition to the basis of the above. For example, the above user table may be represented as “userprimaryid:1”, “username:Lucy”, and “useraddress:Lucy”, and the regular index on the row with the id listed as “a” in the game table (b) may be represented as “gamename: game 1” or “gamestatus: open”, which shall not be limited by the embodiments.

In the above embodiment, corresponding values, “key” and “value”, are generated from various data in the data table through corresponding arrangement methods, and that the generated values of “key” and the “value” are stored in the corresponding storage areas, that achieves an object of automatically storing all relative data of the contents thereof in the kv database, so as to greatly reduce the cost of manually storing all the data of the data table in the kv database and enhance the working efficiency thereof. In addition, this method ensures that all relations of the data can be completely stored within the kv database without omission and render querying and acquisition of required data easier and more reliable.

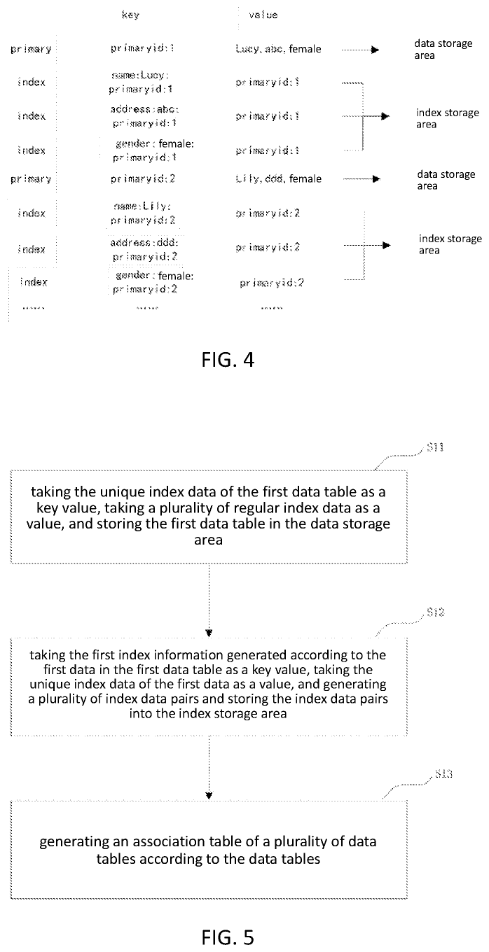

FIG. 4 is a schematic view illustrating an application of the method according to the above preferred embodiment shown in FIG. 2. Referring to FIG. 4, the first index information described in the aforesaid method also comprises the unique index data of the first data.

Specifically, as shown in FIG. 4, the unique index data is further comprised behind the first index information. Namely, the first index information of the unique index as “idl” and the regular index as “name” also comprises “primaryid:1”, so the corresponding key is “name:Lucy:primaryid:1” and the corresponding key of the regular index “address” is “address:Lucy:primaryid:1” and the corresponding key of the regular index “gender” is “gender:Lucy:primaryid:1”. Similarly, the generation method of the “key” and “value” of the regular index of the unique index of id2 would be the same as above that is not being repeated herein.

According to the above preferred embodiment, by adding a corresponding unique index data within the first index information, redundancy of the data content is avoided, such that even though there could also be identical index data contents, since the unique index data are different, the first index information generated will be different and have uniqueness.

In other embodiments, there may be the unique index data or data information, such as 1, 2, 3, A, B, C, a, b, c . . . , and etc. behind the first index information as long as the first index information has the uniqueness in the data table, wherein the specific contents shall not be limited in the embodiments.

Further, preferably, when there is no unique index data in the first data table, the unique index data would be automatically arranged for the first data table. In other words, when the data being not unique in the data table, the system would automatically assign a unique index data for the data table, such as in form of serial numbers (1, 2, 3 . . . ), alphabet (A, B, C . . . ), random combinations of these data, and etc., as long as it has the uniqueness in the table.

Further, the unique index data has a fixed number of bits, and if not, filling zero in front of the unique index data to satisfy the number of bits; specifically, for the example as illustrated in FIG. 1, the numbers below the id are 1, 2, 3 . . . etc., and the bit number configured in the unique index data in the KV database is 20 digits and zeros are filled in front of the number with less than 20 digits, such that, for example, after the zero filling, 1 becomes 00000000000000000001, 2 becomes 00000000000000000002, 10 becomes 00000000000000000010, and 11 becomes 00000000000000000011.

FIG. 5 is a flow diagram of the preferred embodiment of the method as shown in FIG. 2. Referring to FIG. 5, according to the preferred embodiment, the above method also comprises the following step: S13, generating an association table of a plurality of data tables according to the data tables, wherein the association table comprises index data combinations of the data tables and the unique index data corresponding to the index data combinations in the data tables.

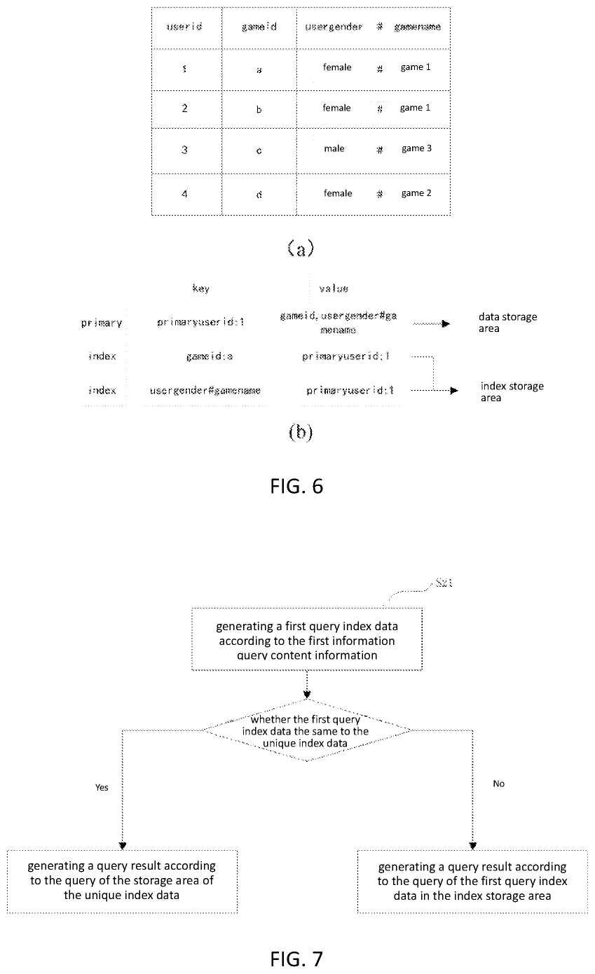

In particular, referring to FIG. 6, for the example of the user table (a) and game table (b) as illustrated in FIG. 1, the relation between the gender in the user table and the name in the game table are stored in the database and the storage form is the same as illustrated in FIG. 2, which is not being repeated herein. Similarly, other relationships of the user table (a) and the game table (b) as illustrated in FIG. 1 may be corelated to generate several other association tables.

FIG. 7 is a flow diagram of a KV database query method according to the preferred embodiment of the present invention. FIG. 7 illustrates a KV database query method, which database is generated through the method illustrated in FIG. 4. The KV database query method, adapted for single-table querying, comprises:

S21 generating a first query index data according to a first information query content information and determining if the first query index data the same to the unique index data:

if yes, generating a query result according to a query of the storage area of the unique index data;

if no, generating a query result according to a query of the first query index data in the index storage area.

Specifically, if a query of all of the data of Lucy is required, construct a first query index data: “name: Lucy,” for determining if the data is the unique index data and, if not, search through the first query index data “name: Lucy” in the index storage area, wherein the query path is “name:Lucy:primaryid:1 primaryid:1.” After the “primaryid:1” is acquired, acquire all of the data (Lucy, abc, female) about Lucy from the data storage area. If a query of all of the data of id=1 is required, based on the data structure query of the first query index data, determine that the data is the unique index data and directly query through the data in the data storage area, wherein the query path is “primaryid:1 Lucy, abc, female.”

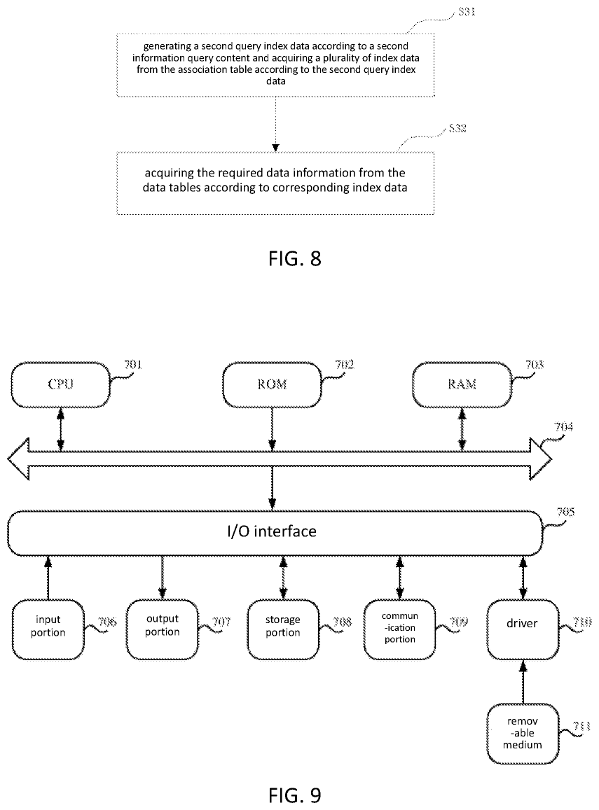

FIG. 8 is a flow diagram of another KV database query method according to the preferred embodiment of the present invention. FIG. 8 illustrates a KV database query method, which database is generated through the method illustrated in FIG. 5. The KV database query method, adapted for association table querying, comprises:

S31 generating a second query index data according to a second information query content and acquiring a plurality of index data from the association table according to the second query index data; and

S32 acquiring required data information from the data tables according to corresponding index data.

Specifically, if a query of the data regarding female playing game 1 is required, as illustrated in FIG. 6, generate a second query index data according to “female#game 1” and acquire corresponding values from the index storage area based in corresponding “key” as well as acquire “primaryuserid: 1.” Then, based on the “primaryuserid: 1”, query and gain “game: a”. Then, based on the “game: a”, query the required data from the KV database of the game table (FIG. 1 (b)).

The above method is also suitable for querying multiple association tables with the same structural principles and method, which is not being repeated herein.

FIG. 9 is a composition diagram of a device according to the preferred embodiment of the present invention.

Referring to FIG. 7, in another aspect, the present invention also provides a device 700, which includes one or more central processing units (CPUs) 701 that executes various actions and data in accordance with one or more programs stored in a read-only memory (ROM) 702 or one or more programs loaded in a random access memory (RAM) 703 from a storage portion 708. Various programs and data required for the operation of the device 700 are also stored in the RAM 703. The CPU 701, the ROM 702, and the RAM 703 are connected to each other via a bus 704. An input/output (I/O) interface 705 is also connected to the bus 704.

The following components are connected to the I/O interface 705: an input portion 706 including a keyboard, a mouse, and etc.; an output portion 707 including a cathode ray tube (CRT), a liquid crystal display (LCD), and etc., and a speaker and etc.; a storage portion 708 including a hard disk or the like; and a communication portion 709 including a network interface card, such as a LAN card, a modem, and etc.. The communication portion 709 executes a communication process via a network, such as the Internet. A driver 710 is also connected to the I/O interface 705 based on the needs. A removable media 711, such as magnetic disks, optical disks, magneto-optical disks, semiconductor memories, and etc., is mounted on the driver 710 based on the needs so that the computer programs read therefrom can be installed into the storage portion 708 as needed.

In particular, according to the embodiments of the present invention, the KV database configuration method and query method described in any of the above embodiments may be implemented as the computer program. For example, an embodiment of the present invention may provide a computer program product, which includes a computer program tangibly loaded on a machine-readable medium containing program codes for executing the KV database configuration method and query method. According to such embodiments, the computer programs may be downloaded and installed through the network by the communication portion 709 and/or installed from the removable medium 711.

As yet another aspect, the present invention also provides a computer-readable storage medium, which may be a computer-readable storage medium included in the device as described the above preferred embodiment, or a computer-readable storage medium that may be provided independently, without being installed in a device. The computer-readable storage medium stores one or more programs that are utilized by one or more processors to execute the KV database configuration method and query method disclosed in the present invention.

The flow chart and block diagrams in the figures illustrate the constructions, functionality, and operation of possible implementations of the systems, methods, and computer program products according to various preferred embodiments of the present invention. In this regard, each block in the flow chart or block diagrams may represent a module, segment, or portion of code, which includes one or more executable instructions for implementing the specified logical function (s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the preferred embodiments of the present invention may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself.

The above description is merely preferred embodiment(s) of the present invention and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

What is claimed is:

1. A KV database configuration method, comprising the steps of:
taking the unique index data of the first data table as a key value, taking a plurality of regular index data as a value, and storing the first data table in the data storage area;
taking the first index information generated according to the first data in the first data table as a key value, taking the unique index data of the first data as a value, and generating a plurality of index data pairs and storing the index data pairs into the index storage area,
wherein the first index information includes the name of the first index, and the index data of the first index in the first data.

2. The method, as recited in claim 1, wherein the first index information also comprises a unique index data of the first data.

3. The method, as recited in claim 1 or 2, when the unique index data is absent from the first data table, automatically disposing the unique index data for the first data table.

4. The method, as recited in claim 3, wherein according to the method as recited in claim 1 or 2, wherein the unique index data has a fixed number of bits, and if not, filling zero in front of the unique index data to satisfy the number of bits.

5. The method, as recited in claim 4, further comprising a step of:
generating an association table of a plurality of data tables according to the data tables, wherein the association table comprises index data combinations of the data tables and the unique index data corresponding to the index data combinations in the data tables.

6. A KV database query method, based on a KV database configured according to the method as recited in claim 2, wherein the method, adapted for single-table querying, comprises the following steps:
generating a first query index data according to the first information query content information and determining if the first query index data the same to the unique index data:
if yes, generating a query result according to the query of the storage area of the unique index data;
if no, generating a query result according to the query of the first query index data in the index storage area.

7. A KV database query method, based on a KV database configured according to the method as recited in claim 5, wherein the method, adapted for association table querying, comprises the following steps:
generating a second query index data according to a second information query content and acquiring a plurality of index data from the association table according to the second query index data;
acquiring the required data information from the data tables according to corresponding index data.

8. A device, comprising:
one or more processors;
a storage, adapted for storing one or more programs, wherein
when said one or more programs are executed by said one or more processor, said one or more processors are allowed to execute the method, as recited in any of the claims 1- 7.

9. A storage medium with a program stored therein, wherein said program is executed by a processor so as to perform the method as recited in any of the claims 1- 7.
